(19) United States
(12) Patent Application Publication
(10) Pub. No.: US 2005/0060192 A1
(43) Pub. Date: Mar. 17, 2005

(54) Healthcare information apparatus and method

(76) Inventors: Alan H. Brown, Tarzana, CA (US); Marc G. Lawson, San Diego, CA (US); Stephen A. Settlage, North Hollywood, CA (US)

Correspondence Address: CATALYST LAW GROUP, APC, 4330 LA JOLLA VILLAGE DRIVE SUITE 220, SAN DIEGO, CA, 92122, US

(21) Appl. No.: 10/715,006

(22) Filed: Nov. 17, 2003

Related U.S. Application Data
(60) Provisional application No. 60/499,414, filed on Aug. 28, 2003.

(51) Int. Cl. G06F 17/60

(52) U.S. Cl. 705/2

(57) ABSTRACT

The present invention relates generally to an improved apparatus and method for providing and/or processing patients' healthcare information by a user wherein said patients' healthcare information is located on a secured server.

### RELATED APPLICATION

This application claims priority from U.S. Provisional Application No. 60/499,414 filed on Aug. 29, 2003.

### FIELD OF THE INVENTION

The present invention relates generally to an apparatus and a method for processing and/or for providing healthcare information and/or healthcare-related information and, more particularly, to an apparatus and a method for processing and/or for providing access of healthcare information and/or healthcare-related information from a secured HIPAA compliant server to an authorized user.

### BACKGROUND OF THE INVENTION

Each year, tens of millions of individuals seek or need the assistance of healthcare professionals. In order to perform proper diagnoses and to prescribe appropriate treatments, healthcare providers typically rely on information, which is obtained from patients, relatives of patients, previous healthcare providers, and/or healthcare facility and/or hospital staff members. Although there is a significant need to provide healthcare providers with accurate and up-to-date data and/or information on patients' health condition, there is also a growing concern that the confidentiality of this information may be compromised.

The first-ever federal privacy standards to protect patients' medical records and other health information provided to health plans, doctors, hospitals and other healthcare providers took effect on Apr. 14, 2003. Developed by the Department of Health and Human Services (HHS), these new standards provide patients with access to their medical records and more control over how their personal health information is used and disclosed. As part of the Health Insurance Portability and Accountability Act of 1996 (HIPAA), it included provisions designed to encourage electronic transactions and also required new safeguards to protect the security and confidentiality of patients' health information. Finally, most health insurers, pharmacies, doctors and other healthcare providers are required to comply with these federal standards.

The new privacy regulations, under HIPAA, ensure minimum privacy protections for patients by limiting the ways that health plans, pharmacies, hospitals, healthcare providers and other covered entities can obtain and use patients' personal medical information. The regulations protect medical records and other individually identifiable health information, whether it is on paper, in computers or communicated orally. As such, personal health information generally may be used for purposes related to healthcare, and covered entities may use or share only the minimum amount of protected information needed for a particular purpose. In addition, patients would have to sign a specific authorization before a covered entity could release their medical information to a life insurer, a bank, a marketing firm or another outside business for purposes not related to their healthcare. Currently, as the prior art discloses, patients' healthcare information is stored on a database that is readily accessible by all such entities.

Stories constantly emerge about patients receiving the wrong treatments, having the wrong surgical procedures performed on them, receiving a drug or drugs which fatally and/or otherwise adversely interact with another drug or drugs, and/or etc., with stories going on and on. Recently, it has been estimated that between 44,000 and 98,000 individuals die, in the United States alone, as the result of errors or mistakes made by doctors, healthcare providers, and/or healthcare facility workers. There is no doubt that many of these deaths result from inaccurate and/or erroneous information and/or the lack of the availability of correct and/or up-to-date information.

Another problem lies with the fact that the main source of patient information, medical histories, family histories, etc., upon which doctors or other healthcare providers may base their diagnoses and/or treatments, are patients who usually supply this information on questionnaires or forms just prior to seeing the healthcare provider and/or during a preliminary interview with the provider. In this regard, information obtained from these questionnaires or forms, as well as from these preliminary interviews with the providers, may not necessarily result in sufficient, comprehensive, and/or accurate, information being obtained regarding the patient. Further, there is no guarantee that the same information will be provided, in a uniform manner, to a next or different provider. As a result of the prior art's requirement of a processor on a user's computer, patients' healthcare information may not be efficiently stored nor accurately updated.

It is also no secret that healthcare costs are rising at ever-increasing rates and that insurance companies and other healthcare payers expend great resources in processing and reconciling treatment claims and/or claims for healthcare services and/or benefits. Typically, these insurance and/or benefits claims take place in a paper-based environment and, as a result are slow and inefficient. Fraudulent claims and/or claims which cannot be verified pose another major problem for healthcare payers and insurance companies. These problems only serve to add to the growing costs of healthcare, delayed treatments, and a general dissatisfaction with the current healthcare system.

There are a number of patents and publications that describe an apparatus and/or method for processing healthcare information: U.S. patent application Ser. No. 09/162,889 (Joao); U.S. Pat. No. 5,961,332 (Joao); and U.S. Pat. No. 6,283,761 (Joao). However, to date, among other things, the prior art apparatuses and methods for processing patients' healthcare information fail to provide an effective, accurate, and confidential means to process patients' healthcare information in order for healthcare providers to submit reports to third party payers in a HIPAA compliant manner. The present invention satisfies these and other needs.

### SUMMARY OF THE INVENTION

The present invention generally relates to an apparatus and method for providing, processing and accessing healthcare information healthcare through a secured website and stored on a secured server.

In contrast to the prior art, in a preferred embodiment of the present invention, the secured website is HIPAA compliant. More particularly, the present invention is advantageous in providing healthcare providers and third party payers with not only efficient information collection, processing and dissemination, cost efficiency, cost containment, consistent, and updated patients' healthcare information but also with storing patients' healthcare information on a secured HIPAA compliant server. Therefore, because of these significant advantages, patients are effectively and cost efficiently treated as well as the confidentiality of their healthcare information is maintained.

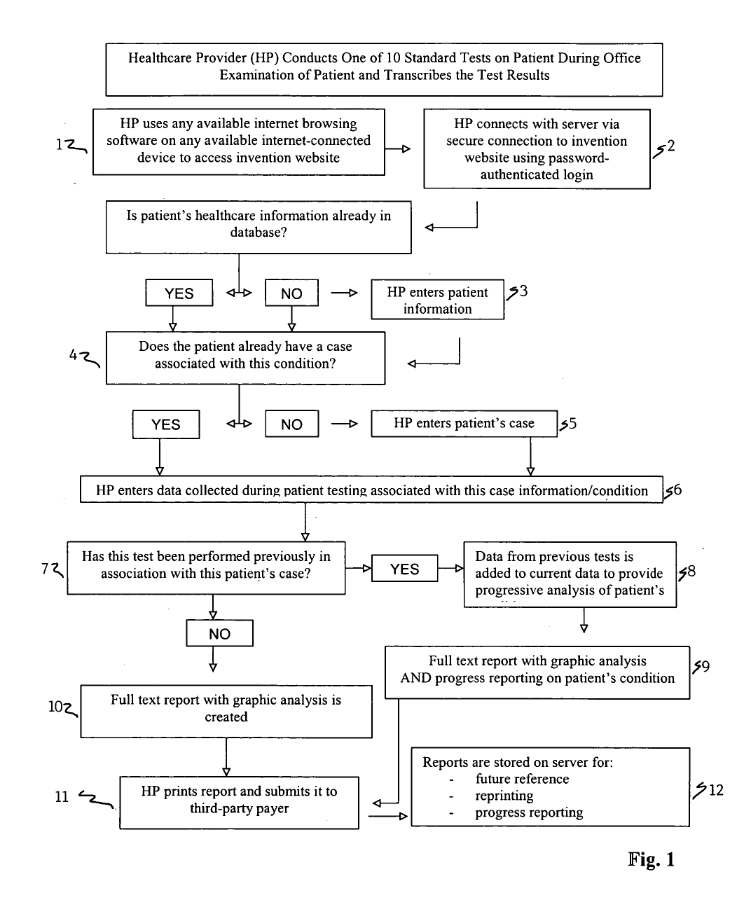

### BRIEF DESCRIPTION OF FIG. 1

FIG. 1 is a schematic representation of a preferred embodiment of the apparatus and method of the present invention.

### DETAILED DESCRIPTION OF THE INVENTION

Abbreviations and Terms

In accordance with the present invention and as used herein, the following terms and abbreviations are defined with the following meanings, unless explicitly stated otherwise. These explanations are intended to be exemplary only. They are not intended to limit the terms as they are described or referred to throughout the specification. Rather, these explanations are meant to include any additional aspects and/or examples of the terms as described and claimed herein.

The following abbreviations are used herein:

HP=healthcare provider
HIPAA=Health Insurance Portability and Accountability Act
HHS=Health and Human Services
   The following terms are used herein:

The term “healthcare provider” refers to a chiropractor, osteopath, physician, physical therapist, nurse, acupuncturist, and other healthcare provider.

The term “device” refers to various computers and/or communication devices for allowing provider access to the Internet, which can be utilized to transmit and/or to receive transmissions, information, messages, and/or notification messages and/or signals, to and/or between, the respective parties associated with the respective computers and/or communication devices. The transmission of information, messages, and/or notification messages and/or signals can be effected via any one or more of e-mail messages, telephone messages, beeper or pager messages, electronic data transmission, and/or can be made via any other suitable and/or appropriate communication method and/or technique.

The term “user” refers to a healthcare provider.

The terms “disease” or “condition” refer to a pain or decreased function that affects the human body.

The term “case” refers to a person's health condition that is involved in a medical/legal situation.

The term “standard tests” refers to any test or measurement utilized to assess (qualitatively or quantitatively) a disease or condition in a patient. Among other things, standard tests include, but are not limited to, outcome assessment/activities of pain index tests, electronic range of motion test, electronic muscle test, grip strength test, and posture analysis.

The term “unique identifier” refers to a confidential password, or the like, as well as any other form of security that could be implemented by those of skill in the art.

The term “third party payer” refers to, among other things, insurance companies, worker's compensation adjustors, and/or other medical insurance adjustors.

The term “patient” refers to any person who seeks, receives, and/or is the beneficiary of healthcare services, healthcare-related services, and/or healthcare-related information.

The present invention is embodied in an apparatus and method for providing and processing patients' healthcare information by users on a secured HIPAA compliant environment. Typically, said secured HIPAA compliant environment comprises secured Internet browsing software on a device, such as a personal computer, connected via the Internet to a remote, secured website that is hosted on a secured server. For example, Internet browsing software such as America Online, Internet Explorer, or Netscape. Navigator is downloaded onto a personal computer wherein healthcare provider logs onto secured website. Preferably, said Internet browsing software can be utilized on, or over, the Internet and/or the World Wide Web and/or on, or over, any other communication network or system. More preferably, said Internet browsing software on a device can be utilized on a communication network or system, a telecommunication network or system, a telephone communication network or system, a cellular communication network or system, a wireless communication network or system, a wireless Internet network or system, a wireless World Wide Web network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

Referring now to FIG. 1, wherein a preferred embodiment of the present invention is illustrated in schematic form. After conducting medically appropriate tests and obtaining relevant patient data, healthcare provider 1 uses any available Internet browsing software on any available Internet connected device to access secured/HIPAA compliant website. Preferably, the Internet connected device comprises a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems. More preferably, the Internet connected device comprises a central processing unit (i.e., CPU), which is a microprocessor, microcomputer, minicomputer, macrocomputer, and/or mainframe computer.

In another preferred embodiment of the present invention, an authorized user is a healthcare provider. Typically, an authorized user will have a unique identifier to gain access to patients' healthcare information. For example, an authorized user will have an individual password to gain access to patients' healthcare information. However, those of skill in the art would also consider other forms of security. Preferably, user comprises a chiropractor, osteopath, physician, physical therapist, nurse, acupuncturist, or other healthcare provider. More preferably, user comprises a chiropractor.

As previously noted in FIG. 1, healthcare provider connects with server via secured connection 2 to secured/HIPAA compliant website using password authenticated login. Contrary to the prior art, patients' healthcare information is stored on a secured server. Typically, said server is secured by coding with encryption. However, those of skill in the art will also consider other forms to secure server. Preferably, said website is hosted on a HIPAA compliant server. More preferably, said website is hosted on a certified Secured Socket Layer encryption in said server.

Similarly as noted in FIG. 1, if patient's healthcare information is not already in secured HIPAA compliant database 3, healthcare provider enters patient information. However, if patient's healthcare information is already in secured HIPAA compliant database 4, healthcare provider asks whether patient already has a case associated with this disease or condition. If no, healthcare provider 5 enters new patient's case information in secured HIPAA compliant database. If yes, healthcare provider enters additional data collected 6 during patient testing, including standard testing, associated with this disease or condition. If this test 7 has been performed previously in association with patient's disease or condition, data from previous tests 8 is added to current data to provide progressive analysis of patient's disease or condition. Typically, patient's healthcare information is continually processed and stored in the database. For example, patients' health condition information is processed and then stored in database after each examination with healthcare provider. Preferably, patients' health condition changes over time are processed and stored onto a secured server. More preferably, patients' health condition changes over time are processed so that said changes are used to create a full text report with graphic analysis of said changes.

Finally, full text report 9 with graphic analysis and progress reporting on patient's disease or condition is printed and submitted to third party payer. Reports 12 are stored on server for future reference, reprinting, and progress reporting. Typically, a third party payer is a worker's compensation claims adjustor and/or other medical insurance adjustor. However, those of skill in the art would consider third party payer to include other insurance adjustors. For example, users can access and print patients' healthcare information that generates instant examination reports with full text analysis and representative graphs. Preferably, healthcare provider prints out examination reports to track the effectiveness of ongoing patient treatment. More preferably, healthcare provider prints out examination reports for worker's compensation claims adjustors to document the progress of patient's treatment.

While the foregoing has been with reference to specific embodiments of the invention, it will be appreciated by those of skill in the art that these are illustrations only and that changes in these embodiments can be made without departing from the principles of the invention, the scope of which is defined by the appended claims.

1. An apparatus for providing users with access to healthcare information wherein said healthcare information is accessed through a secured website and stored on a secured server.

2. The apparatus according to claim 1, wherein said users comprise chiropractors, osteopaths, physicians, nurses, acupuncturists, or other healthcare providers.

3. The apparatus according to claim 1, wherein said access comprises Internet browsing software on an Internet connected device.

4. The apparatus according to claim 1, wherein said user has said access to said healthcare information by using a unique identifier.

5. The apparatus according to claim 4, wherein said unique identifier is a confidential password.

6. The apparatus according to claim 3, wherein said Internet connected device comprises a personal computer, a personal digital assistant, a wireless telephone, a wired telephone, or a palm pilot.

7. The apparatus according to claim 1, wherein said healthcare information comprises patient's symptom(s) and disease or condition information.

8. The apparatus according to claim 1, wherein said secured website is compliant under the Health Insurance Portability and Accountability Act.

9. The apparatus according to claim 1, wherein data on said secured website is coded.

10. A method for providing users with patient's healthcare information, wherein said method comprises processing said patient's healthcare information on a HIPAA compliant website.

11. The method according to claim 10, wherein said patient's healthcare information data of patient's disease or condition is input into said HIPAA compliant website.

12. The method according to claim 11, wherein said data comprises progressive analysis of said patient's healthcare information.

13. The method according to claim 10, wherein said patient's healthcare information data is processed in a text report.

14. The method according to claim 10, wherein said patient's healthcare information data comprise data from previous patient testing.

15. The method according to claim 13, wherein said text report comprises a graphic analysis of said patient's healthcare information changes over time.

16. The method according to claim 13, wherein said text report is printable by said users.

17. The method according to claim 13, wherein said text report is submitted to said third party payer.

18. The method according to claim 17, wherein said third party payer comprise worker's compensation insurance adjustor and/or other medical insurance adjustor.
